(19) United States
(12) Patent Application Publication
(10) Pub. No.: US 2010/0074808 A1
(43) Pub. Date: Mar. 25, 2010

(54) Plasma generating system

(76) Inventor: Sang Hun Lee, San Ramon, CA (US)

Correspondence Address: JORDAN AND HAMBURG LLP, 122 EAST 42ND STREET, SUITE 4000, NEW YORK, NY, 10168, US

(21) Appl. No.: 12/284,570

(22) Filed: Sep. 23, 2008

(51) Int. Cl. B01J 19/08

(52) U.S. Cl. 422/186.04

(57) ABSTRACT

The present invention provides a plasma generating system that includes a nozzle and a gas flow tube. The nozzle includes a housing having a cavity formed therein, where the cavity forms a gas flow passageway, and a rod-shaped conductor disposed in the cavity and operative to transmit microwave energy along the surface thereof so that the microwave energy excites gas flowing through the cavity. The gas flow tube is disposed in a chamber containing an excitation energy and having an inlet disposed at a downstream end of the gas flow passageway so that the gas exiting the cavity flows through the gas flow tube and is excited by the excitation energy.

### BACKGROUND OF THE INVENTION

1. Field of the Invention

The present invention relates to plasma generators, and more particularly to devices having a nozzle that discharges a plasma plume.

2. Discussion of the Related Art

In recent years, the progress on producing plasma by use of microwave energy has been increasing. Typically, a plasma producing system includes a device for generating microwave energy and a nozzle that receives the microwave energy to excite gas flowing through the nozzle into plasma. One of the difficulties in operating a conventional plasma producing system is providing an optimum condition for plasma ignition—a transition from the gas into the plasma. Several parameters, such as gas pressure, gas composition, nozzle geometry, material properties of nozzle components and the intensity of microwave energy applied to the nozzle, for instance, may affect the plasma ignition condition. The threshold intensity of the microwave energy for plasma ignition can be lowered if the microwave energy transfer from the nozzle to the gas increases. Thus, there is a need for a plasma producing system that has enhanced microwave energy transfer from the nozzle to the gas.

### SUMMARY OF THE INVENTION

According to one aspect of the present invention, a plasma generating system includes a nozzle and a gas flow tube. The nozzle includes a housing having a cavity formed therein, where the cavity forms a gas flow passageway, and a rod-shaped conductor disposed in the cavity and operative to transmit microwave energy along the surface thereof so that the microwave energy excites gas flowing through the cavity. The gas flow tube is disposed in a chamber containing an excitation energy and having an inlet disposed at a downstream end of the gas flow passageway so that the gas exiting the cavity flows through the gas flow tube and is excited by the excitation energy.

According to an embodiment of the present invention a plasma generating system includes at least one nozzle. The at least one nozzle has a housing having a cavity formed therein, the cavity forming a gas flow passageway; and a rod-shaped conductor disposed in the cavity and operative to transmit microwave energy into the cavity so that the microwave energy excites the gas flowing through the cavity. Further provided is a chamber configured to receive an excitation energy, and a gas flow tube disposed in the chamber and having an inlet disposed at a downstream end of the gas flow passageway such that the gas exiting the cavity flows through the gas flow tube and is excited by the excitation energy.

According to a feature of the present invention, the above-described embodiment further includes a primary waveguide in which a portion of the rod-shaped conductor is disposed and to which a first end of the nozzle is secured.

According to another feature of the present invention, an embodiment as described above is optionally configured such that the chamber is an additional waveguide having a waveguide inlet connected to a waveguide outlet of the primary waveguide and a second end of the nozzle is secured to the chamber.

According to still another feature of the present invention, an embodiment as described above is optionally configured such that the chamber is an additional waveguide coupled to a first microwave supply unit and the primary waveguide is coupled to a second microwave supply unit.

According to yet another feature of the present invention, an embodiment as described above is optionally configured such that the chamber is an additional waveguide branched off of the primary waveguide.

According to still yet another feature of the present invention, an embodiment as described above is optionally configured such that the chamber is a generally cylindrical shell and includes an inlet connected to a waveguide outlet of the primary waveguide.

According to a further feature of the present invention, an embodiment as described above is optionally includes an electrical insulator disposed in the cavity and adapted to hold the rod-shaped conductor relative to the housing. In a particular exemplary embodiment, the electrical insulator includes at least one through hole formed therein to effect fluid communication between the primary waveguide and the cavity via the through hole and wherein the gas is provided to the cavity via the primary waveguide and the through hole.

According to still further feature of the present invention, an embodiment as described above is optionally configured such that the housing includes a gas inlet hole.

According to a yet further feature of the present invention, an embodiment as described above is optionally configured such that the chamber is a generally cylindrical shell and adapted to contain RF energy therein as the excitation energy. This feature may be embodied using an antenna for providing the RF energy into the chamber disposed in the chamber. Still further, the antenna is preferably one of a spiral coil and a plate, however other configurations are considered within the scope of the invention.

According to another feature of the present invention, an embodiment as described above is optionally configured such that the chamber has a wall which forms the gas flow tube.

The above, and other objects, features and advantages of the present invention will become apparent from the following description read in conjunction with the accompanying drawings, in which like reference numerals designate the same elements. The present invention is considered to include all functional combinations of the above described features and is not limited to the particular structural embodiments shown in the figures as examples. The scope and spirit of the present invention is considered to include modifications as may be made by those skilled in the art having the benefit of the present disclosure which substitute, for elements or processes presented in the claims, devices or structures or processes upon which the claim language reads or which are equivalent thereto, and which produce substantially the same results associated with those corresponding examples identified in this disclosure for purposes of the operation of this invention. Additionally, the scope and spirit of the present invention is intended to be defined by the scope of the claim language itself and equivalents thereto without incorporation of structural or functional limitations discussed in the specification which are not referred to in the claim language itself. Still further it is understood that recitation of the preface of “a” or “an” before an element of a claim does not limit the claim to a singular presence of the element and the recitation may include a plurality of the element unless the claim is expressly limited otherwise. Yet further it will be understood that recitations in the claims which do not include “means for” or “steps for” language are not to be considered limited to equivalents of specific embodiments described herein.

### BRIEF DESCRIPTION OF THE DRAWINGS

FIG. 1 shows a schematic diagram of a plasma generating system in accordance with one embodiment of the present invention.

FIG. 2 shows an exploded view of a portion of the plasma generating system of FIG. 1.

FIG. 3 shows a side cross-sectional view of the portion of the plasma generating system of FIG. 2, taken along the line III-III.

FIG. 4 shows a schematic diagram of a plasma generating system in accordance with another embodiment of the present invention.

FIG. 5 shows a schematic diagram of a plasma generating system in accordance with yet another embodiment of the present invention.

FIG. 6 shows an exploded view of a portion of a plasma generating system in accordance with still another embodiment of the present invention.

FIG. 7 shows a schematic diagram of a plasma generating system in accordance with further another embodiment of the present invention.

FIG. 8A shows a perspective view of a portion of the plasma generating system of FIG. 7.

FIG. 8B shows a front view of an antenna of the type that might be used in the plasma generating system of FIG. 7 in accordance with another embodiment of the present invention.

FIG. 8C shows a perspective view of an antenna of the type that might be used in the plasma generating system of FIG. 7 in accordance with another embodiment of the present invention.

FIG. 9 shows a perspective view of a portion of a plasma generating system in accordance with further yet another embodiment of the present invention.

FIG. 10 shows a side cross-sectional view of a portion of a plasma generating system in accordance with further still another embodiment of the present invention.

### DETAILED DESCRIPTION OF THE PREFERRED EMBODIMENTS

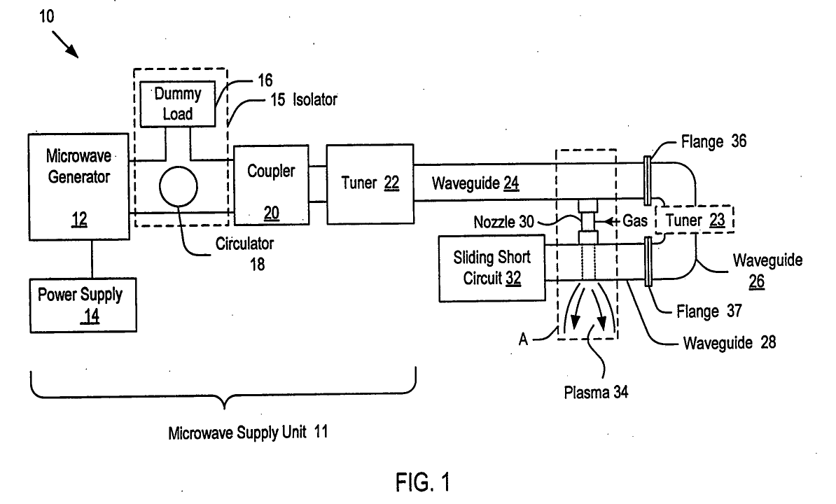

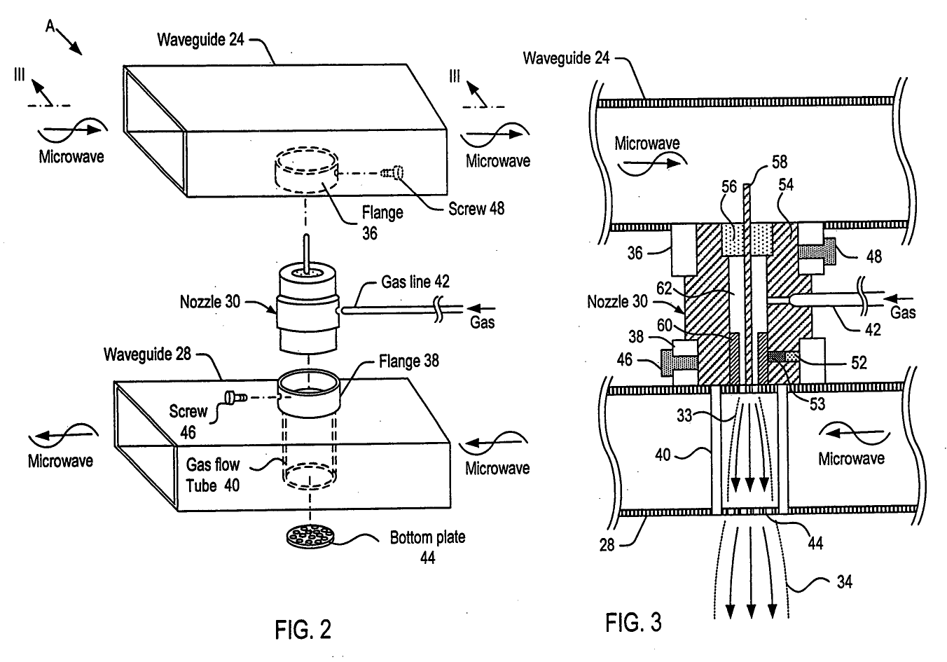

FIG. 1 shows a schematic diagram of a plasma generating system 10 in accordance with one embodiment of the present invention. As illustrated, the system 10 includes: a first (or primary) microwave cavity/waveguide 24; a microwave supply unit 11 for providing microwave energy to the first microwave waveguide 24; a nozzle 30 connected to the first microwave waveguide 24 and operative to receive microwave energy from the first microwave waveguide 24 and excite gas by use of the received microwave energy; a second waveguide 26 coupled to the first waveguide 24 by a flange 36; a third waveguide 28 coupled to the second waveguide 26 by a flange 37; and a sliding short circuit 32 disposed at the end of the third waveguide 28. As described in more detail below in conjunction with FIGS. 2 and 3, the gas excited by the nozzle 30 is excited again as the gas passes through a gas flow tube in the third waveguide 28 and exits the system in the form of plasma 34.

The microwave supply unit 11 provides microwave energy to the first microwave waveguide 24 and includes: a microwave generator 12 for generating microwaves; a power supply 14 for supplying power to the microwave generator 12; and an isolator 15 having a dummy load 16 for dissipating reflected microwave energy that propagates toward the microwave generator 12 and a circulator 18 for directing the reflected microwave energy to the dummy load 16.

The microwave supply unit 11 may further include a coupler 20 for measuring fluxes of the microwave energy; and a tuner 22 for reducing the microwave energy reflected from the sliding short circuit 32 and after-mentioned rod-shaped conductor 58. The components of the microwave supply unit 11 shown in FIG. 1 are well known and are listed herein for exemplary purposes only. Also, it is possible to replace the microwave supply unit 11 with any other suitable system having the capability to provide microwave energy to the microwave waveguide 24 without deviating from the present invention. Likewise, the sliding short circuit 32 may be replaced by a phase shifter that can be configured in the microwave supply unit 11. Typically, a phase shifter is mounted between the isolator 15 and the coupler 20. An additional tuner 23 may be optionally disposed in the second waveguide 26.

FIG. 2 shows an exploded view of a portion A of the plasma generating system 10 of FIG. 1. FIG. 3 shows a side cross-sectional view of the portion A of the plasma generating system 10, taken along the line III-III. As depicted, a ring-shaped flange 36 is affixed to a bottom surface of the first microwave waveguide 24 and the nozzle 30 is secured to the ring-shaped flange 36 by one or more suitable fasteners 48, such as screws. Another ring-shaped flange 38 is affixed to a top surface of the third waveguide 28 and the nozzle 30 is also secured to the ring-shaped flange 38 by one or more suitable fasteners 46, such as screws. A gas flow tube 40, which is formed of material transparent to the microwave, such as quartz, extends through the third waveguide 28.

The nozzle 30 includes a rod-shaped conductor 58; a housing or shield 54 formed of conducting material, such as metal, and having a generally cylindrical cavity thererin so that the cavity forms a gas flow passageway; an electrical insulator 56 disposed in the cavity and adapted to hold the rod-shaped conductor 58 relative to the shield 54; a dielectric tube 60 disposed in the cavity; a spacer 53; and a fastener 52, such as a metal screw, for pushing the spacer 53 against the dielectric tube 60 to thereby secure the dielectric tube 60 to the shield 54. The spacer 53 is formed of dielectric material, such as Teflon®, and functions as a buffer for firmly pushing the dielectric tube 60 against the shield 54 without cracking the dielectric tube 60.

A top portion of the rod-shaped conductor 58 protrudes into the first microwave waveguide 24 and operates as an antenna to capture a portion of the microwave energy in the first waveguide 24. The captured microwave energy flows through the rod-shaped conductor 58. The gas supplied via a gas line 42 is injected into the cavity and excited by the microwave energy flowing through the rod-shaped conductor 58. The gas 33 exiting the nozzle 30 may be neutral or in the form of plasma. The inlet of the gas flow tube 40 is located at the downstream end of the gas flow passageway defined by the cavity. The gas 33 flows through the gas flow tube 40 to be excited again by the microwave energy in the third waveguide 28 so that the gas 34 exiting through the holes formed in a bottom plate 44 is in the form of plasma.

The rod-shaped conductor 58, the dielectric tube 60, and the electric insulator 56 have functions similar to those of their counterparts of a nozzle described in U.S. Pat. No. 7,164,095, which is herein incorporated by reference in its entirety. For brevity, these components are not described in detail in the present document.

It is noted that the gas flowing through the nozzle 30 and the gas flow tube 40 is excited by the microwave energy flowing through the first and third waveguides 24, 28, respectively, while the microwave energy in those waveguides are provided by one microwave supply unit 11. As such, the nozzle system, which collectively refers to the nozzle 30 and the gas flow tube 40, has an enhanced mechanism to excite the gas without increasing the power consumed by the microwave supply unit 11.

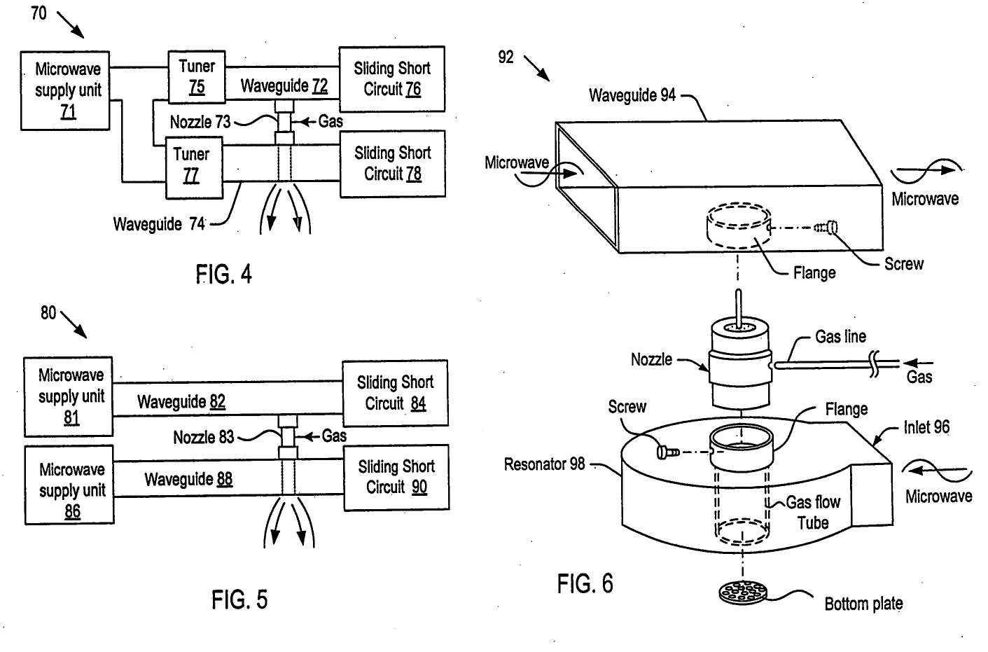

FIG. 4 shows a schematic diagram of a plasma generating system 70 in accordance with another embodiment of the present invention. As depicted, the system 70 is similar to the system 10, with the differences that a waveguide extending from the microwave supply unit 71 is branched into two waveguides 72, 74 and two sliding short circuits 76, 78 are respectively attached to the ends of the waveguides 72, 74. A nozzle 73 is interposed between the two waveguides 72, 74. Optionally, two tuners 75 and 77 may be disposed in the waveguides 72, 74.

FIG. 5 shows a schematic diagram of a plasma generating system 80 in accordance with yet another embodiment of the present invention. As depicted, the system 80 is similar to the system 10, with the differences that two waveguides 82, 88 are respectively coupled to two separate microwave supply units 81, 86 and two sliding short circuits 84, 90 are respectively attached to the ends of the waveguides 82, 88. A nozzle 83 is interposed between the two waveguides 82 and 88.

FIG. 6 shows an exploded view of a portion of a plasma generating system 92 in accordance with still another embodiment of the present invention. The plasma generating system 92 is similar to the system 10, with the difference that the third waveguide 28 of the system 10 is replaced by a resonator 98 having a generally cylindrical shape. The resonator 98 has an inlet 96 through which the microwave energy exiting the waveguide 94 flows. It is noted that the resonator 98 may be also used in the systems 70 and 80. For example, the resonator 98 may be used in place of the waveguide 74 and the sliding short circuit 78 of the system 70. In another example, the resonator 98 may be attached to the waveguide 88 of the system 80 and the sliding short circuit 90 may be omitted.

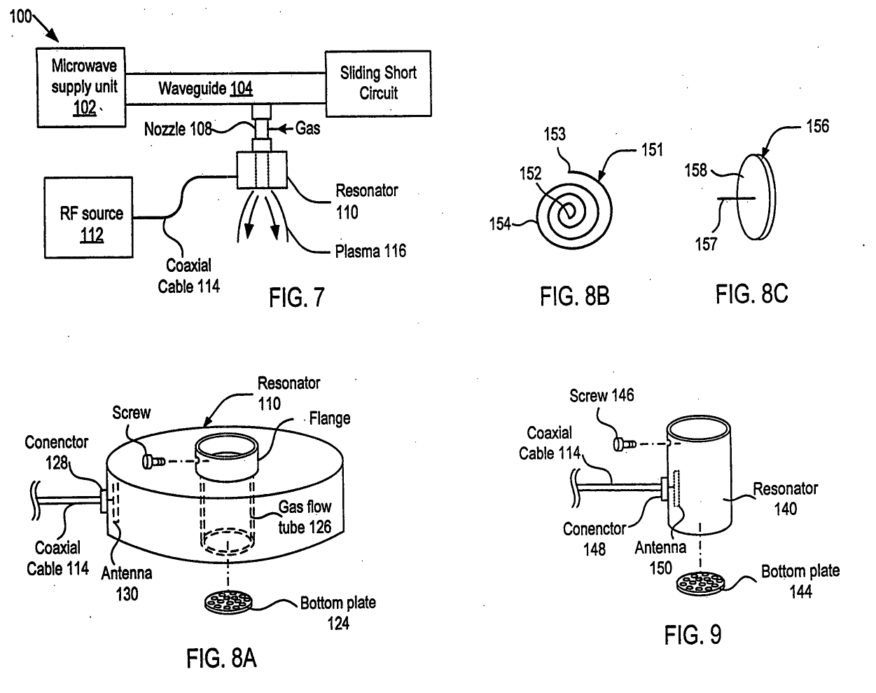

It is noted that the type of excitation energy for exciting the gas flowing through the gas flow tubes, such as 40, in FIGS. 1-6 is microwave energy. Depending on the type of gas flowing through the gas flow tubes, different types of excitation energy, such as RF energy, can be provided in resonators/chambers in which the gas flow tubes are disposed. (Hereinafter, the term chamber refers to a waveguide, a resonator, or any other suitable container housing a gas flow tube, such as 40, and containing excitation energy.) FIG. 7 shows a schematic diagram of a plasma generating system 100 in accordance with further another embodiment of the present invention. FIG. 8A shows a perspective view of a portion of the plasma generating system 100 of FIG. 7. As depicted, a nozzle 108 having the same structure as the nozzle 30 is secured to the waveguide 104 and receives microwave energy transmitted from the microwave supply unit 102 via the waveguide 104. The nozzle 108 is also secured to a resonator 110 by one or more fasteners so that the gas exiting the nozzle 108 passes through a gas flow tube 126 disposed in the resonator 110. RF energy generated by an RF source 112 is transmitted through a coaxial cable 114 to the resonator 110. More specifically, one end of the coaxial cable 114 is coupled to an antenna 130 disposed in the resonator 110 via an RF connector 128. The antenna 130 may have the shape of a plate or a spiral coil. The gas flow tube 126 is formed of material transparent to RF energy.

The gas is excited by the microwave energy in the nozzle 108 such that the gas is in the form of plasma when flowing through the gas flow tube 126. The operational frequency of the RF source 112 may be selected depending on the type and degree of ionization of the plasma flowing through the gas flow tube 126 so that the excitation of the plasma is optimized. The excited plasma exits the resonator 110 via the holes formed in a bottom plate 124.

FIG. 8B shows a front view of an antenna 151 of the type that might be used in the plasma generating system 100 (FIGS. 7 and 8A) in accordance with another embodiment of the present invention. As depicted, the antenna 151 includes a spiral coil 154 having two ends 152, 153 respectively coupled to the inner and outer conductors of a coaxial cable, such as 114, via a connector, such as 128.

FIG. 8C shows a perspective view of an antenna 156 of the type that might be used in the plasma generating system 100 in accordance with another embodiment of the present invention. As depicted, the antenna 156 includes a plate 158 and a conducting rod/wire 157 electrically coupled to the inner conductor of a coaxial cable, such as 114, via a connector, such as 128.

FIG. 9 shows a perspective view of a portion of a plasma generating system in accordance with another embodiment of the present invention. As depicted, the resonator 140 may be of the type that might be used in place of the resonator 110 of FIGS. 7 and 8A. For simplicity, the nozzle 108 to be secured to the resonator 140 by a screw 146 is not shown in FIG. 9. The resonator 140 has the shape of a generally cylindrical shell, where the inner diameter of the resonator is dimensioned to accommodate the nozzle 108. An antenna 150 disposed inside the resonator 140 is coupled to the coaxial cable 114 via a connector 148 secured to the resonator 140. The resonator 140 functions as not only a cavity for containing RF energy therein but also a gas flow tube through which the gas exiting the nozzle 108 flows. The gas, preferably in the form of plasma, exits the resonator 140 through the holes formed in a bottom plate 144.

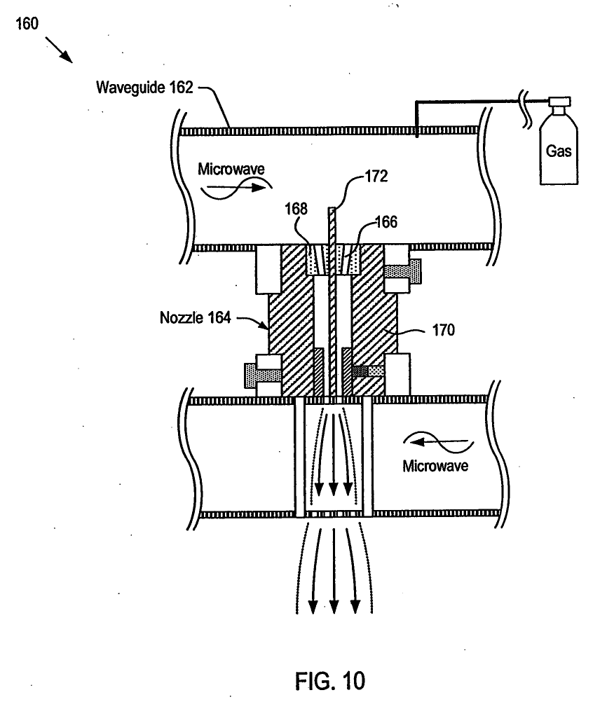

FIG. 10 shows a side cross-sectional view of a portion of a plasma generating system 160 in accordance with another embodiment of the present invention. As depicted, the system 160 is similar to the system 10 of FIG. 3, with the difference in the gas injection system. As depicted, the gas is supplied through a waveguide 162 and through holes 166 formed in an electric insulator 168, i.e., a housing/insulator 170 of the nozzle 164 does not have any gas injection hole. The through holes 166 may be angled relative to the longitudinal axis of a rod-shaped conductor 172 to impart a helical shaped flow direction around the rod-shaped conductor to a gas passing along the through holes 166.

It is noted the gas injection system depicted in FIG. 10 can be applied to the embodiments described in FIGS. 1-9. It is also noted that the plasma generating systems depicted in FIGS. 1-10 have only one nozzle. However, it should be apparent to those of ordinary skill that more than one nozzle can be used in each system. Detailed descriptions of systems having multiple nozzles and methods for operating the systems can be found in U.S. Pat. No. 7,164,095 and U.S. Patent Publication Serial Nos. 2006/0021581, 2006/0021980, 2008/0017616 and 2008/0073202, which are herein incorporated by reference in their entirety.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims. Such modifications include substitution of components for components specifically identified herein, wherein the substitute component provides functional results which permit the overall functional operation of the present invention to be maintained. Such substitutions are intended to encompass presently known components and components yet to be developed which are accepted as replacements for components identified herein and which produce results compatible with operation of the present invention. Furthermore, while examples have been provided illustrating operation at certain frequencies, the present invention as defined in this disclosure and claims appended hereto is not considered limited to frequencies recited herein. Furthermore, the signals used in this invention are considered to encompass any electromagnetic wave transmission.

What is claimed is:

1. A plasma generating system, comprising:
at least one nozzle including:
a housing having a cavity formed therein, said cavity forming a gas flow passageway; and
a rod-shaped conductor disposed in the cavity and operative to transmit microwave energy along the surface thereof so that the microwave energy excites the gas flowing through the cavity; and
a chamber configured to receive an excitation energy; and
a gas flow tube disposed in the chamber and having an inlet disposed at a downstream end of the gas flow passageway such that the gas exiting the cavity flows through the gas flow tube and is excited by the excitation energy.

2. A plasma generating system as recited in claim 1, further comprising a primary waveguide in which a portion of the rod-shaped conductor is disposed and to which a first end of the nozzle is secured.

3. A plasma generating system as recited in claim 2, wherein the chamber is adapted to contain microwave energy therein.

4. A plasma generating system as recited in claim 3, wherein the chamber is an additional waveguide having a waveguide inlet connected to a waveguide outlet of the primary waveguide and a second end of the nozzle is secured to the chamber.

5. A plasma generating system as recited in claim 3, wherein the chamber is an additional waveguide coupled to a first microwave supply unit and the primary waveguide is coupled to a second microwave supply unit.

6. A plasma generating system as recited in claim 3, wherein the chamber is an additional waveguide branched off of the primary waveguide.

7. A plasma generating system as recited in claim 1, wherein the chamber is a generally cylindrical shell and includes an inlet connected to a waveguide outlet of the primary waveguide.

8. A plasma generating system as recited in claim 2, further comprising an electrical insulator disposed in the cavity and adapted to hold the rod-shaped conductor relative to the housing.

9. A plasma generating system as recited in claim 8, wherein the electrical insulator includes at least one through hole formed therein to effect fluid communication between the primary waveguide and the cavity via the through hole and wherein the gas is provided to the cavity via the primary waveguide and the through hole.

10. A plasma generating system as recited in claim 1, wherein the housing includes a gas inlet hole.

11. A plasma generating system as recited in claim 1, wherein the chamber is a generally cylindrical shell and adapted to contain RF energy therein as the excitation energy.

12. A plasma generating system as recited in claim 11, further comprising an antenna for providing the RF energy into the chamber disposed in the chamber.

13. A plasma generating system as recited in claim 12, wherein the antenna is selected from the group consisting of a spiral coil and a plate.

14. A plasma generating system as recited in claim 11, wherein the chamber has a wall which forms the gas flow tube.
